(19) United States
(12) Patent Application Publication
(10) Pub. No.: US 2025/0277899 A1
(43) Pub. Date: Sep. 4, 2025

(54) SURFACE EMITTING LASER-BASED DEVICE FOR LIGHT DETECTION AND RANGING

(71) Applicant: Apple Inc., Cupertino, CA (US)

(72) Inventors: Keith Lyon, San Jose, CA (US); Fei Tan, Sunnyvale, CA (US)

(21) Appl. No.: 18/986,128

(22) Filed: Dec. 18, 2024

Related U.S. Application Data
(60) Provisional application No. 63/614,564, filed on Dec. 23, 2023.

(51) Int. Cl. G01S 7/4911; G01S 17/32

(52) U.S. Cl. CPC G01S 7/4911; G01S 17/32

(57) ABSTRACT

A surface emitting laser (SEL)-based device for light detection and ranging is described. An example device includes a lens, a substrate, a SEL mounted on the substrate, and a circular polarizer. The substrate includes surface couplers and a set of interference couplers. The SEL emits electromagnetic radiation that is modulated according to a continuous wave frequency modulation. The circular polarizer generates a circularly polarized electromagnetic radiation. The first surface coupler directs in-phase and quadrature components of a local oscillator portion of the circularly polarized electromagnetic radiation toward first and second interference couplers and third and fourth interference couplers, respectively. The second surface coupler directs a first component of the signal portion toward the first interference coupler and the third interference coupler. The second surface coupler also directs a second component of the signal portion toward the second interference coupler and the fourth interference coupler.

### CROSS-REFERENCE TO RELATED APPLICATIONS

This application is a nonprovisional and claims the benefit under 35 U.S.C. § 119(e) of U.S. Provisional Patent Application No. 63/614,564, filed Dec. 23, 2023, the contents of which are incorporated herein by reference as if fully disclosed herein.

### FIELD

The described embodiments generally relate to electronic devices and, more particularly, to a surface emitting laser-based device for light detection and ranging.

### BACKGROUND

Modern consumer electronic devices take many shapes and forms and have numerous uses and functions. Smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards, for example, provide various ways for users to interact with others. Such devices may include numerous systems to facilitate such interactions. For example, a smartphone or computer may include a touch-sensitive display for accepting touch or force inputs and providing a graphical output, and many types of electronic devices may include wireless communications systems (e.g., for connecting with other devices to send and receive voice and data content); one or more cameras (e.g., for capturing photographs and videos); or one or more buttons (e.g., depressible buttons, rocker buttons, or crowns (rotatable buttons) that a user may press or otherwise manipulate to provide input to an electronic device).

### SUMMARY

The term embodiment and like terms (e.g., implementation, configuration, aspect, example, and option) are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, the drawings, and each claim.

Some aspects of this disclosure are directed to a surface emitting laser (SEL)-based device for light detection and ranging. In some embodiments, the device includes a lens, a substrate, a surface emitting laser mounted on the substrate, and a circular polarizer. The substrate includes a first surface coupler, a second surface coupler, and a set of interference couplers. The surface emitting laser emits electromagnetic radiation that is modulated according to a continuous wave frequency modulation. The circular polarizer receives the electromagnetic radiation and generates a circularly polarized electromagnetic radiation. The first surface coupler directs an in-phase component of a local oscillator portion of the circularly polarized electromagnetic radiation toward a first interference coupler and a second interference coupler of the set of interference couplers. The first surface coupler also directs a quadrature component of the local oscillator portion of the circularly polarized electromagnetic radiation toward a third interference coupler and a fourth interference coupler of the set of interference couplers. The second surface coupler receives, via the lens, a signal portion of the circularly polarized electromagnetic radiation that is reflected from a target. The second surface coupler also directs a first component of the signal portion toward the first interference coupler and the third interference coupler. The second surface coupler also directs a second component of the signal portion toward the second interference coupler and the fourth interference coupler.

Some aspects of this disclosure are directed to a system for light detection and ranging. In some embodiments, the system includes a substrate that includes a plurality of couplers, a lens coupled to the substrate, a plurality of photodetectors mounted to the substrate, and a plurality of surface emitting lasers mounted to the substrate. The lens is configured to direct a signal electromagnetic radiation reflected from a target toward the substrate. Each surface emitting laser of the plurality of surface emitting lasers is coupled with a circular polarizer to generate a circularly polarized electromagnetic radiation. The substrate is configured, for each surface emitting laser of the plurality of surface emitting lasers, to direct, via a first coupler of the plurality of couplers, one or more of an in-phase component or a quadrature component of a local oscillator portion of the circularly polarized electromagnetic radiation toward a set of one or more interference couplers of the plurality of couplers. The substrate is further configured, for each surface emitting laser of the plurality of surface emitting lasers, to direct, via a second coupler of the plurality of couplers, one or more of a first component or a second component of the signal electromagnetic radiation toward the set of one or more interference couplers. The substrate is further configured, for each surface emitting laser of the plurality of surface emitting lasers, to optically interfere, at the set of one or more interference couplers and to generate a set of optical outputs that are provided to the plurality of photodetectors, one or more of the in-phase component with the first component or the quadrature component with the first component.

Some aspects of this disclosure are directed to a system for light detection and ranging. In some embodiments, the system includes a lens to direct a signal electromagnetic radiation reflected from a target, and an array of unit cells. Each unit cell of the array of unit cells includes a SEL, a circular polarizer, a set of one or more interference couplers, a first coupler formed in the portion of the substrate, and a second coupler formed in the portion of the substrate. The SEL is mounted on a portion of the substrate. The circular polarizer generates a circularly polarized electromagnetic radiation. The set of one or more interference couplers is formed in the portion of the substrate. The first coupler directs one or more of an in-phase component or a quadrature component of a local oscillator portion of the circularly polarized electromagnetic radiation toward the set of one or more interference couplers. The second coupler receives the signal electromagnetic radiation, and directs one or more of a first component or a second component of the signal electromagnetic radiation toward the set of one or more interference couplers. The set of one or more interference couplers is configured to couple one or more of the in-phase component with the first component or the quadrature component with the first component.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the described embodiments, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B show a front isometric view and a rear isometric view of an example electronic device, according to certain aspects of the present disclosure.

FIG. 2 shows an example block diagram, which may include a device incorporating surface emitting laser-based devices for light detection and ranging, according to certain aspects of the present disclosure.

FIG. 3 shows an example device, which may include a device incorporating surface emitting laser-based devices for light detection and ranging, according to certain aspects of the present disclosure.

FIG. 4 shows an example device, which may include a device incorporating surface emitting laser-based devices for light detection and ranging, according to certain aspects of the present disclosure.

FIG. 5 shows an example device, which may be a surface emitting laser-based device for light detection and ranging, according to certain aspects of the present disclosure.

FIG. 6 shows an example method, according to one or more aspects described herein.

FIG. 7 shows another example method, according to one or more aspects described herein.

FIG. 8 shows an example electrical block diagram of an electronic device having a light detection and ranging device, such as one of the surface emitting laser-based devices for light detection and ranging described herein.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

The present disclosure is susceptible to various modifications and alternative forms, and some representative embodiments have been shown by way of example in the drawings and will be described in detail herein. It should be understood, however, that the described embodiments are not intended to be limited to the particular forms disclosed. Rather, the disclosure is to cover all modifications, equivalents, and alternatives falling within the spirit and scope of the described embodiments as defined by the appended claims.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Various embodiments are described with regard to a consumer electronics device, such as a smartphone, wearable device, hand-held device, computer, or dashboard. However, reference to a consumer electronics device, or a particular type of consumer electronics device, is merely provided for illustrative purposes. The example embodiments may be utilized with, include, or be included in any electronic system, device, or component described herein. Therefore, the electronic device described herein is used to represent any appropriate electronic device.

Light detection and ranging (LIDAR), is a remote sensing technology that uses laser light to measure distances and create detailed, three-dimensional maps of the surroundings. LIDAR generally operates on the principle of sending laser pulses and measuring the time it takes for the light to return after reflecting off one or more objects, which may also generally be referred to as a “target.” By analyzing the returned signals, LIDAR systems can generate highly accurate and precise data about the shape, distance, and even surface characteristics of objects in the field of view. LIDAR is widely used in various applications, and can provide detailed and real-time spatial information for precise mapping and object detection.

Frequency modulate continuous-wave (FMCW) radar is a remote sensing technology, which may be commonly used for distance and speed measurements. FMCW radar involves the emission of a continuous signal (e.g., signal light) with a frequency that changes linearly over time. The emitted signal reflects off objects in the path of the signal light, and the frequency shift between the transmitted and received signals is analyzed to determine the distance to the target (a range), as well as a velocity of the target. Continuous operation may allow for FMCW radar to provide accurate and real-time information, which may be used for applications such as automotive collision avoidance systems, radar altimeters, and industrial sensing applications.

FMCW is a powerful tool to obtain high resolution spatial information of targets with lower photon energy than a time-of-flight method. Existing FMCW techniques may use edge emitting lasers (EELs) for FMCW. Techniques using EELs have several drawbacks, including a high cost of integrating the EEL with silicon photonics, and challenges in accurate alignment to couple light for the EEL to silicon photonic waveguides. As such a lower cost solution using semiconductor (e.g., silicon, including silicon (Si) or silicon nitride (SiNx)) photonic substrates or polymer substrates (e.g., printed circuit board (PCB)) are desired for FMCW radar, including FMCW LIDAR.

Moreover, FMCW may be considered for applications such as depth-sensing or gaze-tracking applications that benefit from or even require higher resolution and noise immunity than available from existing techniques in a compact FMCW design. For example, compact existing FMCW devices use single-polarization and/or single channel coherent detection. Quadrature detection techniques, which can capture the phase of the return signal, can improve resolution and noise immunity for radar and LIDAR. For example, medical-grade swept-source optical coherence tomography (OCT) systems (equivalent to FMCW LIDAR) using dual-polarization quadrature detection have been shown to enable “full-range” distance and instantaneous velocity measurements (which are otherwise ambiguous as to the positive versus negative direction), polarization diversity, and polarization sensing. However, such devices are generally large and unsuitable for many applications.

Quadrature detection for FMCW is desirable for additional reasons. Quadrature detection can be used to cancel phase noise from the laser source. Also, some optical interconnect and data-transmission applications utilize quadrature phase shift keying (QPSK), and the dual-polarization extension of QPSK (DP-QPSK) modulation schemes. Both QPSK and DP-QPSK require a quadrature source at both the transmitter and receiver. In existing designs, for example for silicon-photonics, the in-phase (I) and quadrature (Q) signals are generated from an off-chip light-source using a 90° hybrid coupler. A 90° hybrid coupler is essentially a waveguide device creating a 90° phase shift either by a length of waveguide or a tunable phase-shifter. In some designs, the use of a 90° hybrid coupler limits the pitch of an array of quadrature detectors to an undesirable size (e.g., greater than about 100 micrometers). However, the designs described herein may have a pitch of the array of quadrature detectors that is relatively smaller. For example, the pitch of the described array (e.g., using a surface emitting laser (SEL), including vertical cavity SEL (VCSEL), and grating coupler combination) can be less than 100 micrometers (e.g., about 10 micrometers).

As further described herein, devices for light detection and ranging are described that include a lens, a substrate, and a SEL mounted on a substrate, and a set of photodetectors, which may be mounted on the substrate or integrated into the substrate. The substrate includes a first surface coupler, a second surface coupler, and a set of interference couplers. The first surface coupler and the second surface coupler may be grating couplers in some examples. In other examples, the first surface coupler and the second surface coupler may be wedge couplers. The surface emitting laser emits electromagnetic radiation (light, which may be visible or in the non-visible spectrum) that is modulated according to FMCW. A circular polarizer, which may be a part of the SEL, or a separate component in some cases, generates a circularly polarized electromagnetic radiation from the emission of the SEL. The first surface coupler directs an in-phase component of a local oscillator (LO) portion of the circularly polarized electromagnetic radiation toward a first interference coupler and a second interference coupler. The first surface coupler also directs a quadrature component of a local oscillator portion of the circularly polarized electromagnetic radiation toward a third interference coupler and a fourth interference coupler of the set of interference couplers.

The signal portion of the electromagnetic radiation from the SEL is directed away from the device (e.g., toward a target or other object(s)). In some embodiments, the first surface coupler receives the circularly polarize electromagnetic radiation from a single-emitting SEL, and directs (e.g., by passing most of the energy through the coupler) the light toward the target. In other embodiments, the SEL is dual-emitting (with light emission from top and bottom surface simultaneously), and the first surface coupler receives the LO portion of the circularly polarized light from one side of the SEL, and emits a signal portion of the circularly polarized light from one side of the SEL.

The second surface coupler receives signal electromagnetic radiation reflected from the target and directed toward the second surface coupler using a lens. The second surface coupler directs a first component of the received signal electromagnetic radiation toward two of the interference couplers (the first interference coupler and the third interference coupler) and a second component of the received signal electromagnetic radiation toward a different two of the interference couplers (the second interference coupler and the fourth interference coupler). The interference couplers optically interferes each of the LO portions, both in-phase (I) and quadrature (Q), from the first surface coupler with the signal portions, both first linear (X) and second linear (Y), from the second surface coupler to generate a set of optical outputs that are provided to and detected by the set of photodetectors as X-I, Y-I, X-Q, and Y-Q signals. In one or more embodiments, because the guided mode in the waveguides exiting the first surface coupler and the second surface coupler is TE-polarized, the waveguide couplers (the four interference couplers) can mix any combination of signals (e.g., X-I, Y-I, X-Q, and Y-Q).

As further discussed herein, an array of SELs (e.g., including VCSELs, photonic-crystal SELs (PCSELs), or the like) with surface couplers (e.g., granting couplers) and balanced photodetectors can be used to achieve FMCW 3D mapping. In some embodiments, for example depending on the application, any combination of the four polarization/quadrature channels can be used for sensing. For example, an output signal channel from a single one of X-I, Y-I, X-Q, and Y-Q can be used. Or, two or three output channels from two or three of X-I, Y-I, X-Q, and Y-Q can be used.

Although discussed with reference to LIDAR herein, and specifically FMCW LIDAR, the described devices and methods can also be applied to data transmission or other techniques or applications where dual-polarization quadrature signals are used.

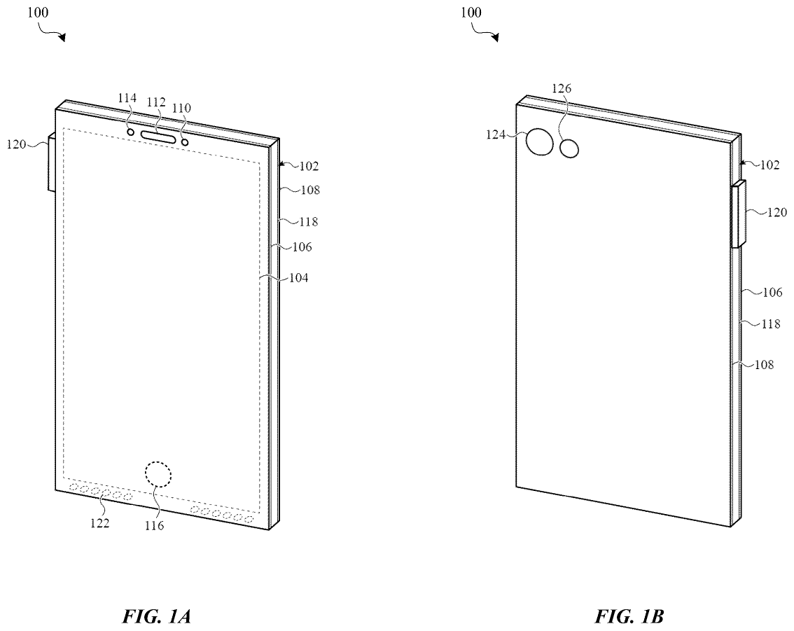

These and other embodiments are discussed below with reference to FIGS. 1A-8. However, those skilled in the art will readily appreciate that the detailed description given herein with respect to these figures is for explanatory purposes only and should not be construed as limiting.

FIG. 1A shows a front isometric view of a device 100, and FIG. 1B shows a rear isometric view of the device 100. Device 100 may include an image sensor or depth sensor. The device's dimensions and form factor, including the ratio of the length of its long sides to the length of its short sides, suggest that the device 100 is a mobile phone (e.g., a smartphone). However, the device's dimensions and form factor are arbitrarily chosen, and the device 100 could alternatively be any portable electronic device including, for example a mobile phone, tablet computer, portable computer, portable music player, wearable device (e.g., an electronic watch, health monitoring device, or fitness tracking device), augmented reality (AR) device, virtual reality (VR) device, mixed reality (MR) device, gaming device, portable terminal, digital single-lens reflex (DSLR) camera, video camera, vehicle navigation system, robot navigation system, or other portable or mobile device. The device 100 could also be a device that is semi-permanently located (or installed) at a single location. The device 100 may include a housing 102 that at least partially surrounds a display 104. The housing 102 may include or support a front cover 106 or a rear cover 108. The front cover 106 may be positioned over the display 104, and may provide a window through which the display 104 may be viewed. In some embodiments, the display 104 may be attached to (or abut) the housing 102 and/or the front cover 106. In alternative embodiments of the device 100, the display 104 may not be included and/or the housing 102 may have an alternative configuration.

The display 104 may include one or more light-emitting elements, and in some cases may be a light-emitting diode (LED) display, an organic LED (OLED) display, a liquid crystal display (LCD), an electroluminescent (EL) display, or another type of display. In some embodiments, the display 104 may include, or be associated with, one or more touch and/or force sensors that are configured to detect a touch and/or a force applied to a surface of the front cover 106.

The various components of the housing 102 may be formed from the same or different materials. For example, a sidewall 118 of the housing 102 may be formed using one or more metals (e.g., stainless steel), polymers (e.g., plastics), ceramics, or composites (e.g., carbon fiber). In some cases, the sidewall 118 may be a multi-segment sidewall including a set of antennas. The antennas may form structural components of the sidewall 118. The antennas may be structurally coupled (to one another or to other components) and electrically isolated (from each other or from other components) by one or more non-conductive segments of the sidewall 118. The front cover 106 may be formed, for example, using one or more of glass, a crystal (e.g., sapphire), or a transparent polymer (e.g., plastic) that enables a user to view the display 104 through the front cover 106. In some cases, a portion of the front cover 106 (e.g., a perimeter portion of the front cover 106) may be coated with an opaque ink to obscure components included within the housing 102. The rear cover 108 may be formed using the same material(s) that are used to form the sidewall 118 or the front cover 106. In some cases, the rear cover 108 may be part of a monolithic element that also forms the sidewall 118 (or in cases where the sidewall 118 is a multi-segment sidewall, those portions of the sidewall 118 that are conductive or non-conductive). In still other embodiments, all of the exterior components of the housing 102 may be formed from a transparent material, and components within the device 100 may or may not be obscured by an opaque ink or opaque structure within the housing 102.

The front cover 106 may be mounted to the sidewall 118 to cover an opening defined by the sidewall 118 (i.e., an opening into an interior volume in which various electronic components of the device 100, including the display 104, may be positioned). The front cover 106 may be mounted to the sidewall 118 using fasteners, adhesives, seals, gaskets, or other components.

A display stack or device stack (hereafter referred to as a “stack”) including the display 104 may be attached (or abutted) to an interior surface of the front cover 106 and extend into the interior volume of the device 100. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 106 (e.g., to a display surface of the device 100).

In some cases, a force sensor (or part of a force sensor system) may be positioned within the interior volume above, below, and/or to the side of the display 104 (and in some cases within the device stack). The force sensor (or force sensor system) may be triggered in response to the touch sensor detecting one or more touches on the front cover 106 (or a location or locations of one or more touches on the front cover 106), and may determine an amount of force associated with each touch, or an amount of force associated with a collection of touches as a whole. In some embodiments, the force sensor (or force sensor system) may be used to determine a location of a touch, or a location of a touch in combination with an amount of force of the touch. In these latter embodiments, the device 100 may not include a separate touch sensor.

The device 100 may include various other components. For example, the front of the device 100 may include one or more front-facing cameras 110 (including one or more image sensors or depth sensors, which in some cases may include one or more of the SEL-based LIDAR devices described herein), speakers 112, microphones, or other components 114 (e.g., audio, imaging, and/or sensing components) that are configured to transmit or receive signals to/from the device 100. In some cases, a front-facing camera 110, alone or in combination with other sensors, may be configured to operate as a bio-authentication or facial recognition sensor. In some embodiments, a flash or electromagnetic radiation source (e.g., a visible or IR light source) may be positioned near the front-facing camera. In some cases, the front-facing camera 110 may be positioned behind the display 104 and receive electromagnetic radiation (e.g., light) through the display 104. In some cases, a depth sensor may be used to determine a distance to a user or generate a depth map of the user's face, or determine a distance or proximity to an object, or generate a depth map of the object or a field of view (FoV) that includes the object. The device 100 may also include various input devices, including a mechanical or virtual button 116, which may be accessible from the front surface (or display surface) of the device 100.

The device 100 may also include buttons or other input devices positioned along the sidewall 118 and/or on a rear surface of the device 100. For example, a volume button or multipurpose button 120 may be positioned along the sidewall 118, and in some cases may extend through an aperture in the sidewall 118. The sidewall 118 may include one or more ports 122 that allow air, but not liquids, to flow into and out of the device 100. In some embodiments, one or more sensors may be positioned in or near the port(s) 122. For example, an ambient pressure sensor, ambient temperature sensor, internal/external differential pressure sensor, gas sensor, particulate matter concentration sensor, or air quality sensor may be positioned in or near a port 122.

In some embodiments, the rear surface of the device 100 may include a rear-facing camera 124 that includes one or more image sensors or depth sensors, which in some cases may include one or more of the SEL-based LIDAR devices described herein. A flash or electromagnetic radiation source 126 (e.g., a visible or IR light source) may also be positioned on the rear of the device 100 (e.g., near the rear-facing camera). In some cases, the rear surface of the device 100 may include multiple rear-facing cameras.

Various examples of electronic devices are described with reference to device 100 that make use of emitted light and received reflections for sensing an exterior environment and objects therein. However, one of ordinary skill in the art will recognize that other types and categories of electronic devices may also make use of emitted light and received reflections for sensing, and that the embodiments disclosed herein are not limited to any particular type or category of electronic device.

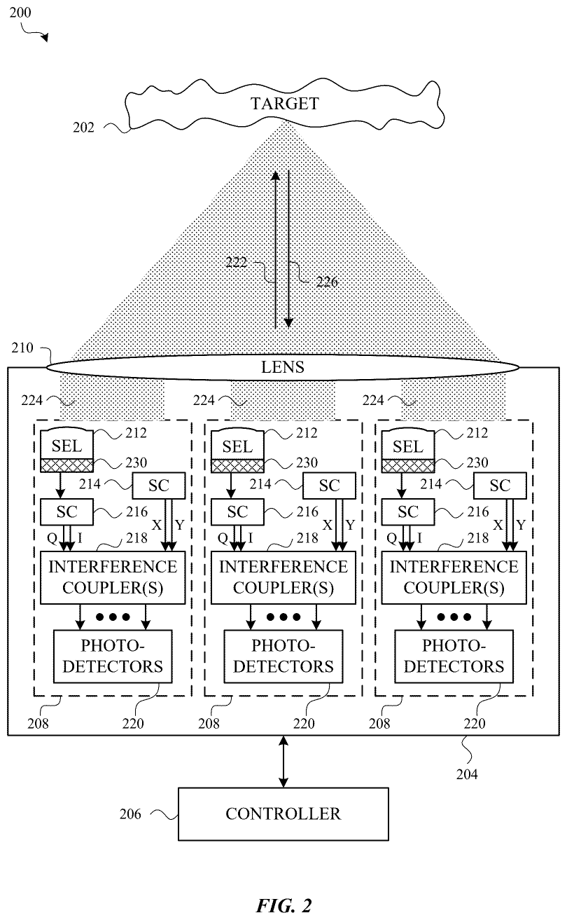

FIG. 2 shows an example block diagram 200, which may include a device incorporating surface emitting laser-based devices for light detection and ranging, according to certain aspects of the present disclosure. Block diagram 200 includes a simplified diagram of a device 204, which may be a portion of a LIDAR device or system. Device 204 may be or include one or more of the various SEL-based LIDAR devices disclosed herein. The device 204 may be used to detect distances to objects in an exterior environment, such as a tree, vehicle, or building. The device 204 may use the detected distances to form a depth map or other image or images of the exterior environment. The device 204 may be handheld, mounted to a handheld mobile or other electronic device such as device 100, mounted to a stationary object, or carried by a moving vehicle or airplane.

The device 204 may emit light, signal light 222, directionally toward a target 202, which may also be referred to as an object and may include multiple targets or objects. In the particular case shown in block diagram 200, the device 204 may emit sequentially within a first plane multiple light pulses as a first set of light pulses, followed by sequentially emitting within a second plane a second set of light pulses. In some cases the first plane is perpendicular to the second plane. Additionally, the device 204 may emit light pulses across more planes, or planes oriented at angles other than 90 degrees to each other. The light pulses may be laser pulses 224, such as may be emitted from one or more laser diodes within the device 204, such as one or more of SEL 212. The plane of an emitted laser pulse 224 and the direction within the plane may be controlled by mechanisms (not shown) within the device 204, such as steerable optics, or by sequential emission of the laser pulses from an array of laser diodes in which the laser diodes are aimed at different directions to allow sweeping, both vertically and horizontally, of the exterior environment.

The device 204 may receive reflected signal light 226 of the emitted light pulses, such as by one or more photodetectors 220, which may be in an array. The photodetectors may be implemented in one or more of various technologies, such as waveguide photodiodes, resonant cavity photodiodes, single photon avalanche diodes, complementary metal-oxide-semiconductor (CMOS) photodetectors, or another technology.

The device 204 may use FMCW techniques to measure directional distance, depth map, and velocity.

In one or more embodiments, the device 204, includes a lens 210 and a plurality of unit cells 208, which may be arranged as an array of unit cells 208. Each unit cell 208 may be associated with a portion or area of a substrate, where the first surface coupler 216, the second surface coupler 214, and the interference coupler 218 are formed in or on the substrate, and the SEL 212 and photodetectors are for the substrate within the portion or area. In some embodiments, the photodetectors are integrated (e.g., at least partially embedded) within the substrate of the unit cell 208. In other embodiments, the photodetectors may be mounted on the substrate. The array of unit cells 208 may be a grid, or other regular pattern or structure, or an irregular arrangement. While a single lens 210 is illustrated for device 204, two or more lenses, a stack of lenses, or another lens assembly may be used consistent with the disclosure herein.

Each unit cell 208 includes an SEL 212, a first surface coupler 216, a second surface coupler 214, a set of interference couplers 218, and a set of photodetectors 220. In some embodiments, the first surface coupler 216, the second surface coupler 214, and the set of interference couplers 218 are formed in or otherwise integrated into a substrate, which may also be referred to as a photonic substrate. The substrate includes optical waveguides that generally direct the energy of the electromagnetic radiation to propagate in a plane parallel to the plane of the substrate. That is, the substrate uses optical waveguides formed within the substrate to direct light in a desired direction. Electromagnetic radiation may also be referred to as “light” herein, for example electromagnetic radiation having a frequency in the visible, ultraviolet, or infrared ranges.

The first surface coupler 216 and the second surface coupler 214 generally direct light away or toward the substrate. For example first surface coupler 216 may receive light that is generally directed toward the face of the substrate, for example light generally propagating in a direction more perpendicular to the plane of the substrate (e.g., from SEL 212) than parallel to the plane of the substrate, and direct a propagation of the light (e.g., via a waveguide of the substrate) to be in a direction more parallel to the plane of the substrate than perpendicular. Such light may be referred to as “local oscillator” light as further discussed herein. Second surface coupler 214 may also receive light that is perpendicular to the substrate (e.g., signal light reflected from the target 202) and direct a propagation of the light to be in a direction more parallel to the plane of the substrate (e.g., via a waveguide of the substrate). Such light may be or be referred to as “signal” light as further discussed herein.

The light emitted by SEL 212 is circularly polarized using a circular polarizer 230. A circular polarizer (e.g., a silicon photonics circular polarizer) is an optical component constructed with materials compatible with silicon-based photonic systems, and designed to selectively filter and manipulate the polarization of incident light through a specific geometric and material configuration that results in the output of circularly polarized light having a specific chirality, or handedness, which is either left hand circularly polarized or right hand circularly polarized.

In some embodiments, SEL 212 includes a circular polarizer 230 incorporated within the structure of the SEL 212. For example, circular polarizer 230 may be one or more layers within a stack of layers of the SEL 212. In other embodiments, circular polarizer 230 is a component formed separately from the structure of the SEL 212. The circular polarizer 230 is then mounted to SEL 212, or otherwise fixed with respect to the SEL 212, to receive light emitted by SEL 212 and output circularly polarized light.

In one or more embodiments, the SEL 212 is a flip-chip bonded VCSEL which is designed to lase in a circularly polarized mode, for example by a gammadion-based two-dimensional grating. In other embodiments, the SEL 212 is a photonic crystal SEL (PCSEL) generating a circularly polarized mode, for example by using a chiral photonic crystal as the cavity of the PCSEL. In still other embodiments, other mechanisms to generate circular polarization are used. For example, the SEL 212 can include chiral materials or metasurfaces, or birefringent materials or metasurfaces, with the VCSEL or PCSEL.

At least some of the circularly polarized light impinging on the first surface coupler 216 interacts with the first surface coupler 216 and is directed in two different directions in the plane of the substrate. The light in the two directions is LO light of the device. An in-phase component or portion (I) of the circularly polarized light is directed in a first direction as an I portion of LO light, and a quadrature component or portion (Q) of the circularly polarized light is directed in a second direction as a Q portion of LO light. For example, first surface coupler 216 may be a two-dimensional grating coupler, and the I portion of light is directed in a direction orthogonal to the direction of the Q portion of light. In some embodiments, the I and Q portions of the light are directed to different interference couplers of the set of interference couplers 218. In some embodiments, the I portion of the light is split (e.g., using an optical splitter formed in the substrate) between a first interference coupler and a second interference coupler of the set of interference couplers 218, and the Q portion of the light is split (e.g., using another optical splitter formed in the substrate) between a third interference coupler and a fourth interference coupler of the set of interference couplers 218.

The outgoing signal light 222 is circularly polarized (e.g., one of left-hand circularly polarized (LHCP) or right-hand circularly polarized (RHCP)), and the reflected signal light 226 is circularly polarized with an opposite handedness (e.g., the other one of RHCP or LHCP). The second surface coupler 214 receives the signal light 222, and circularly polarized light impinging on the second surface coupler 214 interacts with the second surface coupler 214 and is directed in two different directions in the plane of the substrate as two linear components of the signal light. A first linear component or portion (X) of the circularly polarized light is directed in a first direction as an X portion of the signal light, and a second linear component or portion (Y) of the circularly polarized light is directed in a second direction as a Y portion of the signal light. In some examples, second surface coupler 214 may be a two-dimensional grating coupler, and the X portion of light is directed in a direction orthogonal to the direction of the Y portion of light. In some embodiments, the X and Y portions of the light are directed to different interference couplers of the set of interference couplers 218 to interact with the I and Q portions of the light from the first surface coupler 216. In some embodiments, the X portion of the light is split (e.g., using an optical splitter formed in the substrate) between the first interference coupler and the third interference coupler of the set of interference couplers 218, and the Y portion of the light is split (e.g., using another optical splitter formed in the substrate) between the second interference coupler and the fourth interference coupler of the set of interference couplers 218. As such, the set of interference couplers 218 cause the interactions of the combinations of the components of the LO light and the signal light, X-I, Y-I, X-Q, and Y-Q.

As discussed, light from the first surface coupler 216 and light from the second surface coupler 214 are directed toward the set of interference couplers 218 via a set of waveguides. As further discussed herein, one or more additional optical components or sets of waveguides may be within the optical path between the first surface coupler 216 and the set of interference couplers 218, and between the second surface coupler 214 and the set of interference couplers 218. The light (e.g., the signal light and the local oscillator light) is brought in proximity within an active region of the interference coupler and interacts (e.g., interferes according to known optical principles) to produce a set of optical outputs, which are then directed toward the set of photodetectors 220. In an example, each interference coupler of the set of interference couplers 218 has two inputs to receive the signal and LO signals and two outputs that are coupled with two photodetectors (e.g., balanced photodetectors), respectively.

In one or more embodiments, the photodetectors of the set of photodetectors 220 are surface mounted on the substrate. In other embodiments, the photodetectors of the set of photodetectors 220 are integrated within the substrate (e.g., each photodetector is a silicon photonics device at least partially embedded within the substrate). Accordingly, the set of photodetectors 220 may also be associated with a set of surface couplers for the photodetectors, specifically to couple the outputs of the set of interference couplers 218, which each may be propagated via a waveguide, to the sensing portion of the photodetectors of the set of photodetectors 220. In some examples, the surface couplers for the photodetectors may direct each optical output from the set of interference couplers 218 to be generally perpendicular to the surface of the substrate and propagate toward the sensing portion of a photodetector of the set of photodetectors 220.

The second surface coupler 214 generally receives signal light reflected from a target (e.g., objects). The signal light may be propagated away from the device 204 according to different designs or techniques, which are further described herein. In a first device, the signal light to output from the device 204 is directed from the SEL 212 through the substrate via the first surface coupler 216 and second surface coupler 214, where second surface coupler 214 both directs the signal light away from the device 204 toward a target 202, and receives the signal light reflected from the target 202. In a second device, the signal light to output from the device 204 is directed from the SEL 212 through the first surface coupler 216 which directs the signal light away from the device 204 toward a target 202, and the second surface coupler 214 receives the signal light reflected from the target 202. In a third device, the signal light (as a first portion of light) to output from the device 204 is emitted from the SEL 212 in a first direction away from the device 204, while the LO light (as a second portion of light) is emitted from the SEL 212 in a second direction (e.g., opposite the first direction) to the substrate via the first surface coupler 216, and the second surface coupler 214 receives the signal light reflected from the target 202.

As further described herein, the first surface coupler 216 may be a grating coupler or a wedge coupler (or set of wedge couplers), and the second surface coupler 214 may be a grating coupler or a wedge coupler (or set of wedge couplers).

In some embodiments, in addition to photonic elements, components, or structures, the photonic substrate may also include one or more electronic or optoelectronic components, such as integrated electrical conductors, passive components (e.g., resistors, inductors, or capacitors), or active components (e.g., amplifiers, switches, controllers, electrooptical devices, micro-electrical mechanical systems, and so on).

Controller 206 is coupled with the device 204, or may also be a part of device 204. Controller 206 receives electrical outputs from the set of photodetectors 220, and controls the optical output of SEL 212, for example by controlling a source voltage and/or source current of SEL 212. Controller 206 also provides the modulation signal to the SEL 212, for example the FMCW modulation signal.

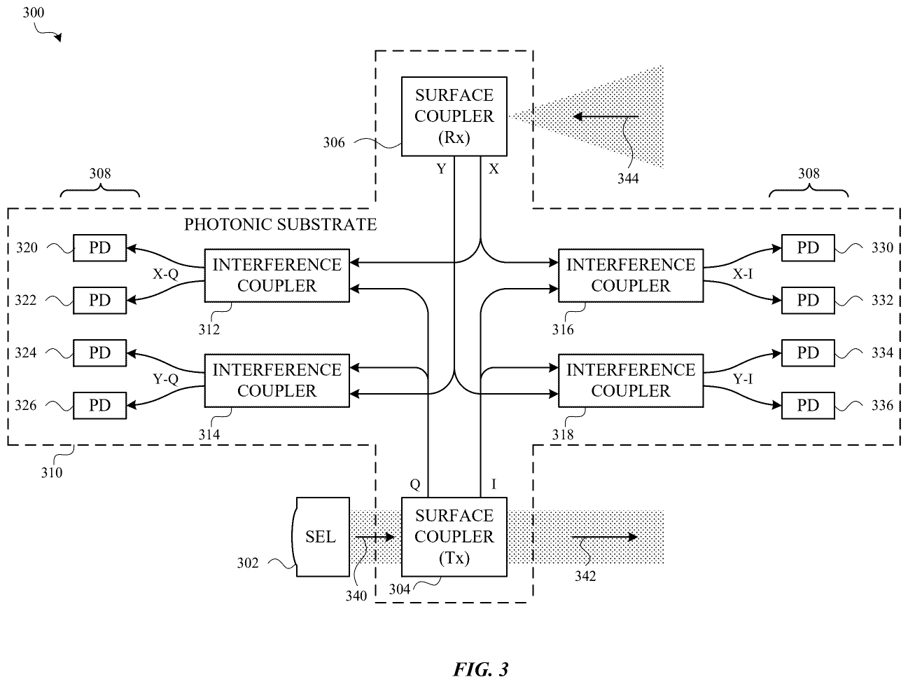

FIG. 3 shows an example device 300, which may be a surface emitting laser-based device for light detection and ranging, according to certain aspects of the present disclosure. Device 300 includes a unit cell 310, which includes a portion of substrate on which is mounted (affixed, bonded, attached) an SEL 302. The unit cell 310 further includes a set of photodetectors 308. In some embodiments, the photodetectors are integrated (e.g., at least partially embedded) within the substrate of the device 300. In other embodiments, the photodetectors may be mounted on the substrate of device 300. In some embodiments, the set of photodetectors 308 include a first photodetector 320, a second photodetector 322, a third photodetector 324, a fourth photodetector 326, a fifth photodetector 330, a sixth photodetector 332, a seventh photodetector 334, and an eighth photodetector 336. The substrate includes a first surface coupler 304, and a second surface coupler 306, a set of an interference couplers (a first interference coupler 312, a second interference coupler 314, a third interference coupler 316, and a fourth interference coupler 318), and optical waveguides coupling these components on or in the substrate of the unit cell 310 as illustrated for device 300.

The set of interference couplers may be configured to generate a set of output signals, specifically the X-I, Y-I, X-Q, and Y-Q described herein with respect to FIG. 2. Specifically, the unit cell 310 is configured to emit outgoing signal light 342 toward a target and to receive reflected signal light 344 that is returned from the target. The outgoing signal light 342 may be directed to a target using the first surface coupler 304, and the reflected signal light 344 may be collected using the second surface coupler 306. Each interference coupler of the set of interference couplers may receive a linear component of the reflected signal light 344 (e.g., one of an X portion and a Y portion of the reflected signal light 344) and may receive a portion of an LO signal (e.g., one of an I portion or a Q portion of the LO signal). As shown in FIG. 3, the first interference coupler 312 receives light of the X portion of the reflected signal light 344 and the Q portion of the LO signal at the respective inputs of the first interference coupler 312. The first interference coupler 312 outputs a first pair of signals that represent the interference between the X and Q portions, and a first pair of balanced photodetectors (including the first photodetector 320 and the second photodetector 322) may measure the first pair of signals to generate the X-Q output signal. The second interference coupler 314 receives light from the Y portion of the reflected signal light 344 and the Q portion of the LO signal and generates a second pair of signals, which are measured by a second pair of balanced photodetectors (including the third photodetector 324 and the fourth photodetector 326) to generate the Y-Q output signal.

Similarly, the third interference coupler 316 receives light from the X portion of the reflected signal light 344 and the I portion of the LO signal and generates a third pair of signals, which are measured by a third pair of balanced photodetectors (including the a fifth photodetector 330 and the sixth photodetector 332) to generate the X-I output signal. The fourth interference coupler 318 receives light from the Y portion of the reflected signal light 344 and the I portion of the LO signal and generates a fourth pair of signals, which are measured by a fourth pair of balanced photodetectors (including the seventh photodetector 334 and the eighth photodetector 336) to generate the Y-I output signal. It should be appreciated that any of these output signals (or combinations thereof) may be analyzed to perform the mapping and object detection operations described herein.

The device 300 may be associated with a lens or other optical components (not shown) to focus signal light toward and away from a target. In some embodiments, the lens may be attached to or coupled with device 300. In other embodiments, the lens may be external to device 300, or a separate component from device 300. One or more of the SEL 302, the set of photodetectors 308, the first surface coupler 304, the second surface coupler 306, the interference couplers (a first interference coupler 312, a second interference coupler 314, a third interference coupler 316, and a fourth interference coupler 318), or the lens may be examples of one or more of SEL 212, the set of photodetectors 220, the first surface coupler 216, the second surface coupler 214, the interference couplers 218, or lens 210, respectively, of FIG. 2. In some embodiments, device 300 may also include one or more splitters (not shown), for example to split LO light or reflected signal light to go to multiple interference couplers.

In one or more embodiments the SEL 302 is a VCSEL, a PCSEL, or a surface-emitting distributed feedback (DFB) laser. In some embodiments the VCSEL, PCSEL, or surface-emitting DFB laser may be flip-chip bonded to the substrate, and the light emission from the SEL 302 is coupled to a waveguide of the substrate (e.g., a silicon-photonics waveguide) via the first surface coupler 304. In some embodiments, the first surface coupler 304 is a grating coupler. In other embodiments, the first surface coupler 304 is a wedge coupler. The first surface coupler 304 is relatively alignment-insensitive compared to an edge emitting laser (EEL) to waveguide approach.

As illustrated for device 300, the SEL 302 (e.g., a VCSEL, PCSEL, or surface-emitting DFB laser) is mounted on a substrate (e.g., a silicon photonics substrate) above the first surface coupler 304 (e.g., a two-dimensional grating coupler or wedge coupler, or a set of grating couplers or wedge couplers, as further discussed herein). SEL 302 is front-emitting in some examples. In some embodiments, SEL 302 has an extended VCSEL cavity formed by a gallium arsenide (GaAs) substrate, with light emission through the substrate (e.g., a silicon substrate). The SEL 302 may be operated to emit light 340 that is incident on the first surface coupler 304. The surface coupler 304 may be configured to receive the incident light 340 and transmit a first portion of the incident light 340 as the signal light 342. The signal light 342 may be directed to a target as described in more detail herein.

The first surface coupler 304 may be further configured to redirect a second portion of the incident light 340 as the LO signal (including the I portion and the Q portion). In some embodiments, the first surface coupler 304 is designed such about 10% of the incident light 340 is coupled into waveguides formed in the substrate (e.g., a Si waveguide for a Si substrate) as the LO signal, including both I portions and Q portions as described herein. The relative amount of the LO signal that is captured from the incident light 340 can be designed (adjusted, tuned, modified) per requirements to be greater than about 10% or less than about 10% as needed. In some embodiments, the reflected and backward beams can be minimized (e.g., simultaneously kept less than a threshold reflected value and less than a threshold backward value) by the design of the first surface coupler 304.

In one or more embodiments, the unit cell 310 includes silicon photonic circuitry, such that the first surface coupler 304, the second surface coupler 306, the set of interference couplers, and associated waveguides are silicon photonic components, for example, such that the components are formed within a silicon substrate. In some embodiments, the silicon substrate is silicon (Si), which may be suitable for light propagation with wavelengths of larger than about 1.08 um. In other embodiments, the silicon nitride (SiNx) waveguide can be formed on a silicon substrate, which is suitable for light propagation with shorter wavelengths (for example, 0.94 um or other wavelengths less than 1.08 um).

In some cases, the device 300 is relatively less sensitive to laser relative intensity (RIN) noise due to the use of balanced photodetection (e.g., first photodetector 320 and second photodetector 322 of the set of photodetectors 308 may be balanced, and so on). In some examples the set of photodetectors 308 are waveguide silicon germanium (SiGe) photodetectors.

In one or more embodiments, the LO power split ratio is determined by the design of the first surface coupler 304. The power split ratio for device 300 may be selected based on system design requirements.

In some embodiments, the SEL 302 (e.g., a VCSEL) may be one of an array of SELs, each associated with a set of parallel silicon-photonics unit cell arrays that can be used to achieve FMCW 3D mapping. The device 300 described herein may be arranged in an array having a relatively tight pitch (e.g., less than about 15 micrometers). An array of grating couplers can also have a tight pitch (e.g., less than about 10 micrometers).

In some embodiments, SEL 302 is an extended cavity VCSEL. In other embodiments, a PCSEL or a surface emitting DFB laser may be used. One advantage of SEL 302 over an EEL, is that an SEL 302 (e.g., a VCSEL) is less sensitive to back-reflection.

In some embodiments, a wavelength of about 1.31 micrometers is used. In other embodiments, a wavelength of about 1.55 micrometers is used. In still other embodiments, a wavelength of about 1.13 micrometers is used, and such a wavelength may provide one or more of the following advantages: (1) being transparent to a silicon waveguide; (2) feasible for gallium arsenide-based VCSELs having good wall plug efficiency (WPE); or (3) 1.13 micrometers is located approximately at the solar ambient light background dip.

In some embodiments, a grating coupler can be fabricated on a VCSEL surface to reach a single polarization. In one or more embodiments, a single polarization can be achieved for a PCSEL via the photonic crystal design.

In some embodiments, a linewidth below a frequency threshold is needed for the FMCW system design. In some embodiments, less than or equal to about 5 MHz linewidth is needed. In some embodiments, for example using a PCSEL for the SEL 302, linewidth of less than about 100 kHz is achievable. In other embodiments, for example using a VCSEL for the SEL 302, an extended cavity within the VCSEL may be needed or used to achieve a linewidth of less than about 5 MHz. In some embodiments, an on-chip lens (OCL) with a top curved dielectric distributed Bragg reflector (DBR) can help achieve the formation of a stable long cavity without diffraction and scatter loss (e.g., substantially without, or with diffraction and/or scatter loss values less than a threshold value) for the VCSEL.

One or both of the first surface coupler 304 or the second surface coupler 306 are designed, or designed for device 300, to have a high efficiency (e.g., an efficiency above an efficiency threshold value), good directionality (e.g., a percentage of light power propagating in a desired direction that is above a power threshold value), low insertion loss (e.g., an insertion loss below an insertion loss threshold value), and/or low back-reflection (e.g., a back-reflection value below a back-reflection threshold value). In one or more embodiments, the first surface coupler 304 is matched to the numerical aperture (NA) of the SEL 302 (e.g., a VCSEL NA), and the second surface coupler 306 is matched to the NA of an input beam size. In some embodiments, the first surface coupler 304 is a grating coupler that is a bidirectional, bilayer, or single-layer dual polarization grating. In one or more embodiments, the second surface coupler 306 is replaced with a vertical edge coupler. In other embodiments, the second surface coupler 306 is replaced with a regular wedge coupler together with micro-optics (e.g., one or more prisms).

In some embodiments, device 300 may further incorporate a meta-optic element (e.g., a metasurface, diffractive optics, and so) to achieve other optical functionality.

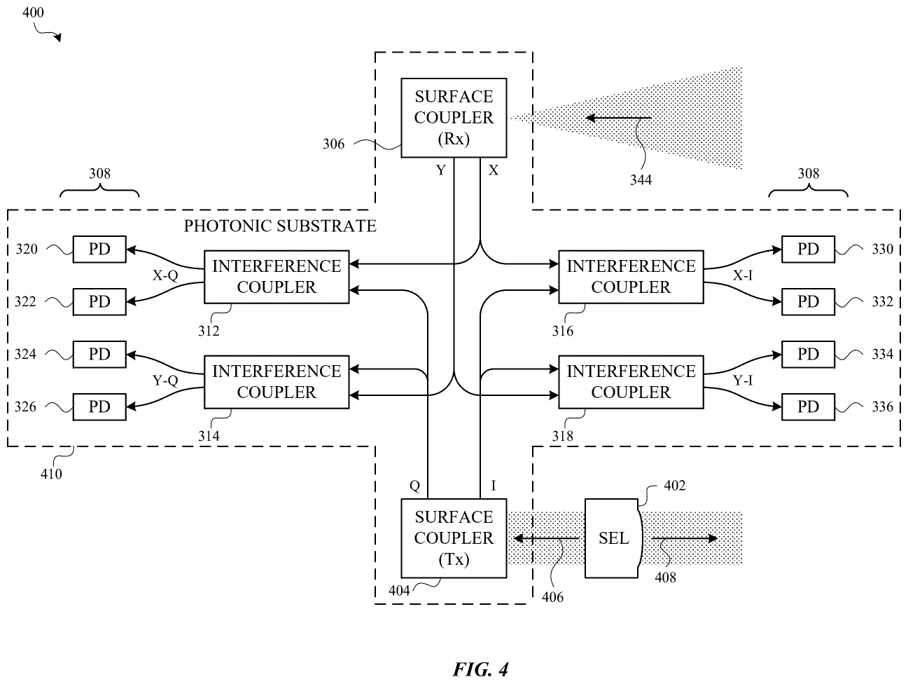

FIG. 4 shows an example device 400, which may be a surface emitting laser-based device for light detection and ranging, according to certain aspects of the present disclosure. Device 400 includes a unit cell 410, which includes a portion of substrate on which is mounted (affixed, bonded, attached) an SEL 402. Unit cell 410 includes aspects of unit cell 310, as further described with reference to device 300, but is different at least with reference to SEL 402 and first surface coupler 404.

In one or more embodiments, device 400 includes SEL 402, which is dual-emitting, with light emission from top and bottom surfaces simultaneously. SEL 402 is a dual-emitting VCSEL or PCSEL in some embodiments, and the substrate is a silicon photonic substrate. In one or more embodiments, the VCSEL is an extended-cavity VCSEL (VECSEL), which is dual-emitting. In one or more embodiments, the SEL 402 (e.g., a VCSEL, PCSEL) is flip-chip bonded to the substrate. The signal light 408 emitted from one side (e.g., the top surface) of SEL 402 is used for target illumination, and reflected signal light 344 may be captured (e.g., via the second surface coupler 306) and interfered with the LO signal. The light 406 emitted from the opposite side (e.g., the bottom surface) of the SEL 402 is coupled to a waveguide (e.g., a Si-photonics waveguide) of the substrate via a grating coupler (e.g., the first surface coupler 404) as the LO source to generate the LO signal. The set of interference couplers (first interference coupler 312, second interference coupler 314, third interference coupler 316, and fourth interference coupler 318), which may be in-plane couplers in one or more embodiments, combines the X and Y components of the reflected signal light with the I and Q components of the LO signal for interference, as described herein.

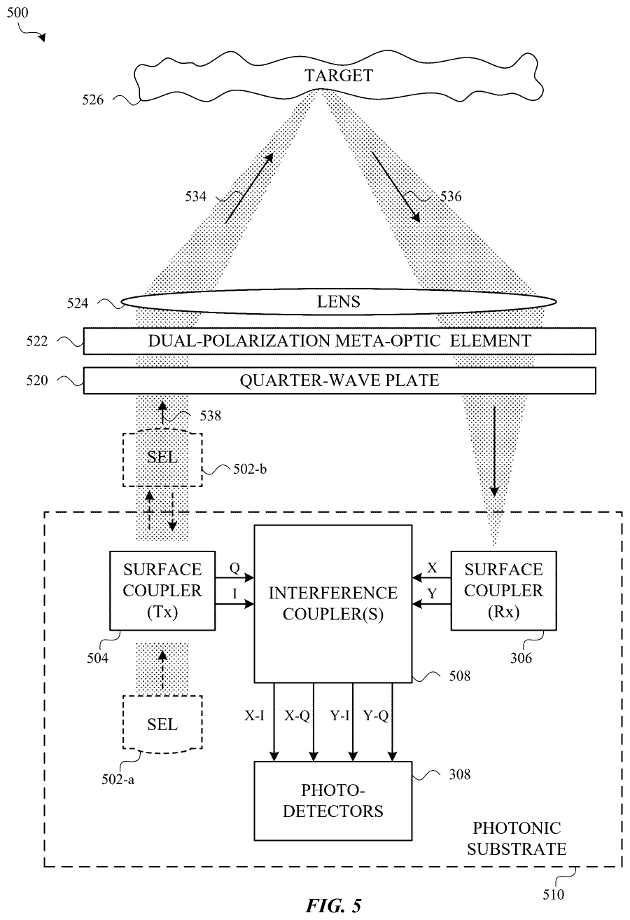

FIG. 5 shows an example device 500, which may be a surface emitting laser-based device for light detection and ranging, according to certain aspects of the present disclosure. Device 500 includes a unit cell 510, which includes a portion of substrate on which is mounted (affixed, bonded, attached) an SEL 502. Unit cell 510 includes aspects of unit cell 310 and unit cell 410, as further described with reference to device 300 and device 400, but includes additional optical elements, and is different at least with reference to SEL 402 and first surface coupler 404.

The device 500 may be associated with a lens 524, dual-polarization meta-optic element 522, and quarter-wave plate 520, to focus and modify a signal light 534 toward a target 526, and focus and modify a signal light 536 returning from the target 526. In some embodiments, one or more of the lens 524, the dual-polarization meta-optic element 522, or the quarter-wave plate 520 may be attached to or otherwise affixed to device 500. In other embodiments the lens 524, dual-polarization meta-optic element 522, or quarter-wave plate 520 may be external to device 500, or a separate component from device 500. One or more of the SEL 502, the set of photodetectors 308, the first surface coupler 504, the second surface coupler 306, the set of interference couplers 508, or the lens 524 may be examples of one or more of SEL 212, the set of photodetectors 220, the first surface coupler 216, the second surface coupler 214, the interference couplers 218, or lens 210, respectively (or one or more of the SEL 302, the set of photodetectors 308, the first surface coupler 304, the second surface coupler 306, or the set of interference couplers (first interference coupler 312, second interference coupler 314, third interference coupler 316, fourth interference coupler 318).

Lens 524 is used to project the signal light 534 (which may also be referred to as a signal beam) to the far-field (e.g., toward a target 526), as well as to collect the signal light 536 (which may be referred to as reflected signal light). In order to direct the reflected signal light, signal light 536, to a separate surface coupler (e.g., a grating-coupler) such as second surface coupler 306, the quarter-wave plate 520 converts the transmitted signal light to circularly polarized, for example the signal light 534 may be RHCP light. Because the reflected signal light, signal light 536, will then be circularly polarized with the opposite handedness (e.g., LHCP for transmitted RHCP light), a dual-polarization meta-optic element 522 creates horizontal focus shift between LHCP and RHCP polarizations. The quarter-wave plate 520 converts the received signal light back to linear polarization.

In other embodiments, the transmitted and received light may use separate lenses. In some embodiments, for the use of separate lenses, the photonics of the substrate (e.g., Si photonics waveguides) and surface couplers (e.g., grating couplers, wedge couplers) span both lenses.

In one or more embodiments, the external optics (e.g., quarter-wave plate 520, dual-polarization meta-optic element 522, and lens 524) are integrated with device 500 at a module level. As further discussed herein, an array of SELs 502 (e.g., array of VCSEL or array of PCSEL) with a grating coupler array can be used to achieve FMCW 3D mapping.

In some embodiments, SEL 502 may be a single-emitting SEL, and in the configuration of SEL 502-a, which is discussed with reference to SEL 302 of device 300 herein. In other embodiments, SEL 502 may be a dual-emitting SEL, and in the configuration of SEL 502-b, which is discussed with reference to SEL 402 of device 400 herein. In either configuration signal light 538 is incident on the quarter-wave plate 520.

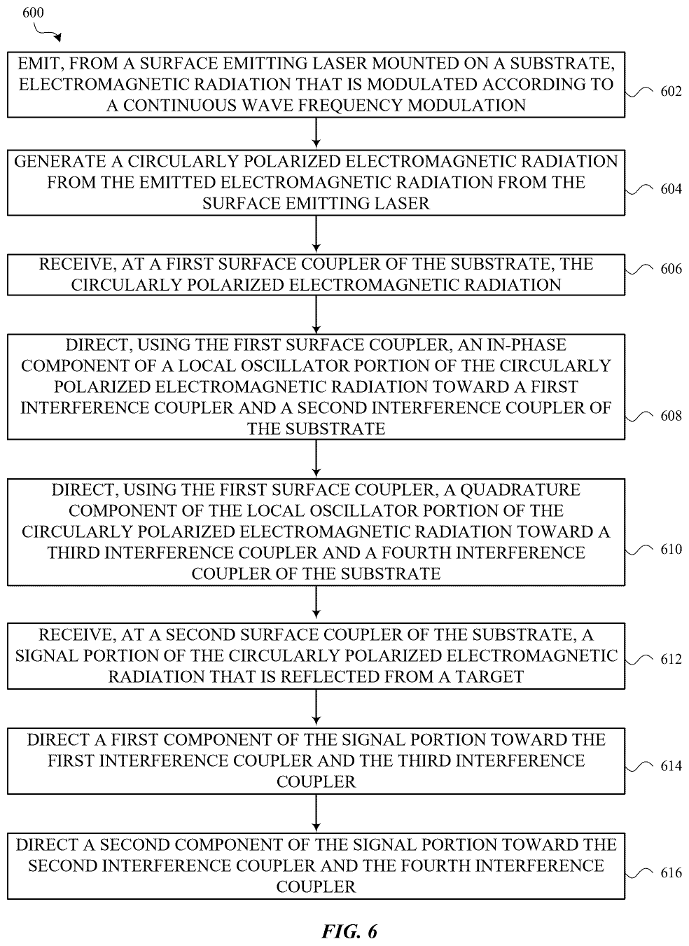

FIG. 6 shows an example method 600, according to one or more aspects described herein. In one or more embodiments, method 600, supports one or more aspects of a surface emitting laser-based device for light detection and ranging, as further described herein. In some cases, the device may be the device 100, electronic device 800, or one of the other devices described herein. The method 600 may be performed using a processor (e.g., a processor 804 and/or a sensor system 810) or other components of the device.

At 602, the method 600 includes emitting, from a surface emitting laser mounted on a substrate, electromagnetic radiation that is modulated according to a continuous wave frequency modulation.

At 604, the method 600 includes generating a circularly polarized electromagnetic radiation from the emitted electromagnetic radiation from the surface emitting laser.

At 606, the method 600 includes receiving, at a first surface coupler of the substrate, the circularly polarized electromagnetic radiation.

At 608, the method 600 includes directing, using the first surface coupler, an in-phase component of a local oscillator portion of the circularly polarized electromagnetic radiation toward a first interference coupler and a second interference coupler of the substrate.

At 610, the method 600 includes directing, using the first surface coupler, a quadrature component of the local oscillator portion of the circularly polarized electromagnetic radiation toward a third interference coupler and a fourth interference coupler of the substrate.

At 612, the method 600 includes receiving, at a second surface coupler of the substrate, a signal portion of the circularly polarized electromagnetic radiation that is reflected from a target.

At 614, the method 600 includes directing a first component of the signal portion toward the first interference coupler and the third interference coupler.

At 616, the method 600 includes directing a second component of the signal portion toward the second interference coupler and the fourth interference coupler.

In one or more embodiments, the method further includes generating a quadrature phase shift keyed (QPSK) signal based on a first output of the first interference coupler, a second output of the second interference coupler, a third output of the third interference coupler, and a fourth output of the fourth interference coupler. In some embodiments, the generating uses a set of photodetectors coupled with the first interference coupler, the second interference coupler, third interference coupler, and the fourth interference coupler.

In one or more embodiments, the method further includes generating, using at least one photodetector, a single channel signal based on one of a first output of the first interference coupler, a second output of the second interference coupler, a third output of the third interference coupler, or a fourth output of the fourth interference coupler.

In one or more embodiments, the method further includes generating, using at least one photodetector, a two channel signal based on a first one of a first output of the first interference coupler, a second output of the second interference coupler, a third output of the third interference coupler, or a fourth output of the fourth interference coupler, and based on a different one of the first output, the second output, the third output, or the fourth output. In some embodiments, generating the two channel signal is based on a different one of the first output, the second output, the third output, or the fourth output.

In one or more embodiments, the method further includes generating, using a first photodetector, a first channel signal based on a first output of the first interference coupler, generating, using a first photodetector, a second channel signal based on a second output of the second interference coupler, generating, using a first photodetector, a third channel signal based on a third output of the third interference coupler, and generating, using a first photodetector, a fourth channel signal based on a fourth output of the fourth interference coupler.

In some embodiments, the circularly polarized electromagnetic radiation is generated using a circular polarizer that is a part of the surface emitting laser.

In some embodiments, the first surface coupler comprises a two-dimensional grating coupler to direct the in-phase component in a first direction of the substrate and to direct the quadrature component in a second direction of the substrate.

In one or more embodiments, the method further includes generating, using a first pair of photodetectors, a first portion of a QPSK signal from a first output of the first interference coupler, generating, using a second pair of photodetectors, a second portion of the QPSK signal from a second output of the second interference coupler, generating, using a third pair of photodetectors, a third portion of the QPSK signal from a third output of the third interference coupler, and generating, using a fourth pair of photodetectors, a fourth portion of the QPSK signal from a fourth output of the fourth interference coupler.

In some embodiments, the first component of the signal portion of the electromagnetic radiation comprises a first linear component of the signal portion, and the second component of the signal portion of the electromagnetic radiation comprises a second linear component of the signal portion, the second linear component orthogonal to the first linear component.

In one or more embodiments, the method further includes directing, using the second surface coupler, the signal portion of the circularly polarized electromagnetic radiation away from the device for reflection from the target.

In one or more embodiments, the method further includes directing, using the first surface coupler, the signal portion of the circularly polarized electromagnetic radiation away from the device for reflection from the target.

In one or more embodiments, the method further includes emitting, by the surface emitting laser, a first portion of electromagnetic radiation toward the first coupler of the substrate and a second portion of electromagnetic radiation away from the device for reflection from the target.

In one or more embodiments, the method further includes directing, using a first lens, the signal portion of the circularly polarized electromagnetic radiation that is reflected from the target toward the device, and directing, using a second lens, the signal portion of the circularly polarized electromagnetic radiation away from the device and toward the target.

The method 600 may be variously embodied, extended, or adapted, as described in the following paragraphs and elsewhere in this description.

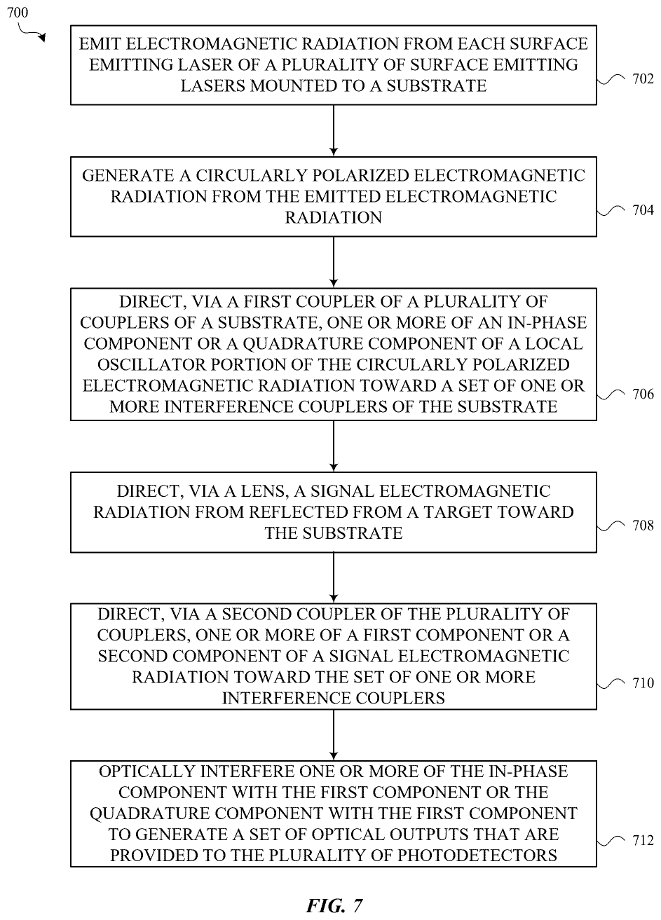

FIG. 7 shows an example method 700, according to one or more aspects described herein. In one or more embodiments, method 700, supports one or more aspects of a surface emitting laser-based device for light detection and ranging, as further described herein. In some cases, the device may be the device 100, electronic device 800, or one of the other devices described herein. The method 700 may be performed using a processor (e.g., a processor 804 and/or a sensor system 810) or other components of the device.

At 702, the method 700 includes emitting electromagnetic radiation from each surface emitting laser of a plurality of surface emitting lasers mounted to a substrate.

At 704, the method 700 includes generating a circularly polarized electromagnetic radiation from the emitted electromagnetic radiation.

At 706, the method 700 includes directing, via a first coupler of a plurality of couplers of a substrate, one or more of an in-phase component or a quadrature component of a local oscillator portion of the circularly polarized electromagnetic radiation toward a set of one or more interference couplers of the substrate.

At 708, the method 700 includes directing, via a lens, a signal electromagnetic radiation reflected from a target toward the substrate.

At 710, the method 700 includes directing, via a second coupler of the plurality of couplers, one or more of a first component or a second component of a signal electromagnetic radiation toward the set of one or more interference couplers.

At 712, the method 700 includes optically interfering one or more of the in-phase component with the first component or the quadrature component with the first component to generate a set of optical outputs that are provided to the plurality of photodetectors.

In one or more embodiments, the method 700 further includes directing, using the first coupler, one of the in-phase component or the quadrature component toward the set of one or more interference couplers, the set of one or more interference couplers including at least a first interference coupler. The method further includes directing, using the second coupler, the first component of the signal electromagnetic radiation toward the first interference coupler. The method further includes coupling, using the first interference coupler, the first component and the one of the in-phase component or the quadrature component.

In one or more embodiments, the method 700 further includes directing, using the first coupler, both the in-phase component and the quadrature component toward the set of one or more interference couplers, the set of one or more interference couplers including at least a first interference coupler and a second interference coupler. The method further includes directing, using the second coupler, the first component of the signal electromagnetic radiation toward the first interference coupler and the second interference coupler. The method further includes coupling, using the first interference coupler, the in-phase component and the first component. The method further includes coupling, using the second interference coupler, the quadrature component and the first component.

In one or more embodiments, the method 700 further includes directing, using the first coupler, both the in-phase component and the quadrature component toward the set of one or more interference couplers, where the set of one or more interference couplers includes at least a first interference coupler, a second interference coupler, a third interference coupler, and a fourth interference coupler. The method further includes directing, using the second coupler, the first component of the signal electromagnetic radiation toward the first interference coupler and the second interference coupler. The method further includes directing, using the second coupler, the second component of the signal electromagnetic radiation toward the third interference coupler and the fourth interference coupler. The method further includes coupling, using the first interference coupler, the in-phase component and the first component. The method further includes coupling, using the second interference coupler, the quadrature component and the first component. The method further includes coupling, using the third interference coupler, the in-phase component and the second component. The method further includes coupling, using the fourth interference coupler, the quadrature component and the second component.

In some embodiments, the circular polarizer is a part of the surface emitting laser, and the surface emitting laser is mounted to the substrate. In some embodiments, the first coupler comprises a two-dimensional grating coupler to direct the in-phase component in a first direction of the substrate and to direct the quadrature component in a second direction of the substrate.

In one or more embodiments, the method 700 further includes providing, by a control circuit, a control signal to cause the surface emitting laser to emit the electromagnetic radiation. The method further includes receiving data signals from a set of one or more photodetectors that are associated with the first interference coupler, the second interference coupler, the third interference coupler, and the fourth interference coupler. The method further includes determining ranging information for the target based on the data signals.

In one or more embodiments, the method 700 further includes selecting, by the control circuit, to receive the data signals from one or more of a first pair of photodetectors, a second pair of photodetectors, a third pair of photodetectors, or a fourth pair of photodetectors of the set of one or more photodetectors. In some embodiments, the first pair of photodetectors is associated with interference between the in-phase component and the first component, the second pair of photodetectors is associated with interference between the quadrature component and the first component, the third pair of photodetectors is associated with interference between the in-phase component and the second component, and the fourth pair of photodetectors is associated with interference between the quadrature component and the second component.

The method 700 may be variously embodied, extended, or adapted, as described in the following paragraphs and elsewhere in this description.

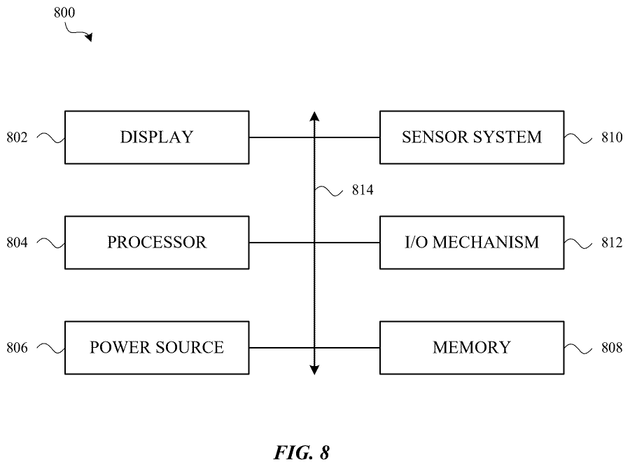

FIG. 8 shows an example electrical block diagram of an electronic device 800 having a light detection and ranging device, such as one of the surface emitting laser-based devices for light detection and ranging described herein. The electronic device 800 may take forms such as a hand-held or portable device (e.g., a smartphone, tablet computer, or electronic watch), a navigation system of a vehicle, and so on. The electronic device 800 may include an optional display 802 (e.g., a light-emitting display), a processor 804, a power source 806, a memory 808 or storage device, a sensor system 810, and an optional input/output (I/O) mechanism 812 (e.g., an input/output device and/or input/output port). The processor 804 may control some or all of the operations of the electronic device 800. The processor 804 may communicate, either directly or indirectly, with substantially all of the components of the electronic device 800. For example, a system bus or other communication mechanism 814 may provide communication between the processor 804, the power source 806, the memory 808, the sensor system 810, and/or the I/O mechanism 812.

The processor 804 may be implemented as any electronic device capable of processing, receiving, or transmitting data or instructions. For example, the processor 804 may be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

In some embodiments, the components of the electronic device 800 may be controlled by multiple processors. For example, select components of the electronic device 800 may be controlled by a first processor and other components of the electronic device 800 may be controlled by a second processor, where the first and second processors may or may not be in communication with each other.

The power source 806 may be implemented with any device capable of providing energy to the electronic device 800. For example, the power source 806 may include one or more disposable or rechargeable batteries. Additionally, or alternatively, the power source 806 may include a power connector or power cord that connects the electronic device 800 to another power source, such as a wall outlet, or a wireless charging circuit.

The memory 808 may store electronic data that may be used by the electronic device 800. For example, the memory 808 may store electrical data or content such as, for example, audio and video files, documents and applications, device settings and user preferences, timing signals, control signals, data structures or databases, image data, maps, or focus settings. The memory 808 may be configured as any type of memory. By way of example only, the memory 808 may be implemented as random access memory, read-only memory, Flash memory, removable memory, other types of storage elements, or combinations of such devices.

The electronic device 800 may also include one or more sensors defining the sensor system 810. The sensors may be positioned substantially anywhere on the electronic device 800. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 810 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, and so on. Additionally, the one or more sensors may utilize any suitable sensing technology, including, but not limited to, capacitive, ultrasonic, resistive, optical, ultrasound, piezoelectric, and thermal sensing technology.

The I/O mechanism 812 may transmit and/or receive data to/from a user or another electronic device. An I/O device may include a display, a touch sensing input surface such as a track pad, one or more buttons (e.g., a graphical user interface “home” button, one of the buttons described herein, or a crown), one or more cameras (including one or more image sensors), one or more microphones or speakers, one or more ports such as a microphone port, and/or a keyboard. Additionally, or alternatively, an I/O device or port may transmit electronic signals via a communications network, such as a wireless and/or wired network connection. Examples of wireless and wired network connections include, but are not limited to, cellular, Wi-Fi, Bluetooth, IR, and Ethernet connections. The I/O mechanism 812 may also provide feedback (e.g., a haptic output) to a user.

In one or more embodiments, the sensor system 810 includes an SEL-based device for light detection and ranging. In some embodiments, the device includes a lens, a substrate, a surface emitting laser mounted on the substrate, and a circular polarizer. The substrate includes a first surface coupler, a second surface coupler, and a set of interference couplers. The surface emitting laser emits electromagnetic radiation that is modulated according to a continuous wave frequency modulation. The circular polarizer receives the electromagnetic radiation and generates a circularly polarized electromagnetic radiation. The first surface coupler directs an in-phase component of a local oscillator portion of the circularly polarized electromagnetic radiation toward a first interference coupler and a second interference coupler of the set of interference couplers. The first surface coupler also directs a quadrature component of the local oscillator portion of the circularly polarized electromagnetic radiation toward a third interference coupler and a fourth interference coupler of the set of interference couplers. The second surface coupler receives, via the lens, a signal portion of the circularly polarized electromagnetic radiation that is reflected from a target. The second surface coupler also directs a first component of the signal portion toward the first interference coupler and the third interference coupler. The second surface coupler also directs a second component of the signal portion toward the second interference coupler and the fourth interference coupler.

In one or more embodiments, the sensor system 810 includes a system for light detection and ranging. In some embodiments, the system includes a substrate that includes a plurality of couplers, a lens coupled to the substrate, a plurality of photodetectors mounted to the substrate, and a plurality of surface emitting lasers mounted to the substrate. The lens is configured to direct a signal electromagnetic radiation reflected from a target toward the substrate. Each surface emitting laser of the plurality of surface emitting lasers is coupled with a circular polarizer to generate a circularly polarized electromagnetic radiation. The substrate is configured, for each surface emitting laser of the plurality of surface emitting lasers, to direct, via a first coupler of the plurality of couplers, one or more of an in-phase component or a quadrature component of a local oscillator portion of the circularly polarized electromagnetic radiation toward a set of one or more interference couplers of the plurality of couplers. The substrate is further configured, for each surface emitting laser of the plurality of surface emitting lasers, to direct, via a second coupler of the plurality of couplers, one or more of a first component or a second component of the signal electromagnetic radiation toward the set of one or more interference couplers. The substrate is further configured, for each surface emitting laser of the plurality of surface emitting lasers, to optically interfere, at the set of one or more interference couplers and to generate a set of optical outputs that are provided to the plurality of photodetectors, one or more of the in-phase components with the first component or the quadrature component with the first component.

In one or more embodiments, the sensor system 810 includes a system for light detection and ranging. In some embodiments, the system includes a lens to direct a signal electromagnetic radiation reflected from a target, and an array of unit cells. Each unit cell of the array of unit cell includes an SEL, a circular polarizer, a set of one or more interference couplers, a first coupler formed in the substrate, and a second coupler formed in the substrate. The SEL is mounted on a portion of the substrate. The circular polarizer generates a circularly polarized electromagnetic radiation. The set of one or more interference couplers is formed in the substrate. The first coupler directs one or more of an in-phase component or a quadrature component of a local oscillator portion of the circularly polarized electromagnetic radiation toward the set of one or more interference couplers. The second coupler receives the signal electromagnetic radiation, and to direct one or more of a first component or a second component of the signal electromagnetic radiation toward the set of one or more interference couplers. The set of one or more interference couplers is configured to couple one or more of the in-phase components with the first component or the quadrature component with the first component.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively.

Additionally, directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. These words are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical, or electromagnetic) capable of traveling through a medium such as DC, AC, sinusoidal-wave, triangular-wave, square-wave, vibration, and the like.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

Although the disclosed embodiments have been illustrated and described with respect to one or more implementations, equivalent alterations and modifications will occur or be known to others skilled in the art upon the reading and understanding of this specification and the annexed drawings. In addition, while a particular feature is disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not as any limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

1. A device, comprising:
a lens;
a substrate comprising a first surface coupler, a second surface coupler, and a set of interference couplers;
a surface emitting laser mounted on the substrate, the surface emitting laser to emit electromagnetic radiation that is modulated according to a continuous wave frequency modulation; and
a circular polarizer to receive the electromagnetic radiation and generate a circularly polarized electromagnetic radiation, wherein:
the first surface coupler directs an in-phase component of a local oscillator portion of the circularly polarized electromagnetic radiation toward a first interference coupler and a second interference coupler of the set of interference couplers, and directs a quadrature component of the local oscillator portion of the circularly polarized electromagnetic radiation toward a third interference coupler and a fourth interference coupler of the set of interference couplers; and
the second surface coupler receives, via the lens, a signal portion of the circularly polarized electromagnetic radiation that is reflected from a target, directs a first component of the signal portion toward the first interference coupler and the third interference coupler, and directs a second component of the signal portion toward the second interference coupler and the fourth interference coupler.

2. The device of claim 1, further comprising:
a set of photodetectors mounted on the substrate and coupled with the set of interference couplers, the set of photodetectors to generate a quadrature phase shift keyed (QPSK) signal based at least in part on a first output of the first interference coupler, a second output of the second interference coupler, a third output of the third interference coupler, and a fourth output of the fourth interference coupler.

3. The device of claim 1, further comprising:
at least one photodetector mounted on the substrate and coupled with the set of interference couplers to generate a single channel signal based at least in part on one of a first output of the first interference coupler, a second output of the second interference coupler, a third output of the third interference coupler, or a fourth output of the fourth interference coupler.

4. The device of claim 1, further comprising:
a first photodetector mounted on the substrate and coupled with the set of interference couplers to generate a first channel signal based at least in part on a first one of a first output of the first interference coupler, a second output of the second interference coupler, a third output of the third interference coupler, or a fourth output of the fourth interference coupler; and
a second photodetector mounted on the substrate and coupled with the set of interference couplers to generate a second channel signal based at least in part on a different one of the first output, the second output, the third output, or the fourth output.

5. The device of claim 1, further comprising:
a set of photodetectors mounted on the substrate and coupled with the set of interference couplers, the set of photodetectors comprising:
a first photodetector to generate a first channel signal based at least in part on a first output of the first interference coupler;
a second photodetector to generate a second channel signal based at least in part on a second output of the second interference coupler;
a third photodetector to generate a third channel signal based at least in part on a third output of the third interference coupler; and
a fourth photodetector to generate a fourth channel signal based at least in part on a fourth output of the fourth interference coupler.

6. The device of claim 1, wherein the circular polarizer is a part of the surface emitting laser.

7. The device of claim 1, wherein the first surface coupler comprises a two-dimensional grating coupler to direct the in-phase component in a first direction of the substrate and to direct the quadrature component in a second direction of the substrate.

8. The device of claim 1, further comprising:
a first pair of photodetectors coupled with the first interference coupler;
a second pair of photodetectors coupled with the second interference coupler;
a third pair of photodetectors coupled with the third interference coupler; and
a fourth pair of photodetectors coupled with the fourth interference coupler.

9. The device of claim 1, wherein:
the first component of the signal portion of the circularly polarized electromagnetic radiation comprises a first linear component of the signal portion; and
the second component of the signal portion of the circularly polarized electromagnetic radiation comprises a second linear component of the signal portion, the second linear component orthogonal to the first linear component.

10. The device of claim 1, wherein the second surface coupler further directs the signal portion of the circularly polarized electromagnetic radiation away from the device for reflection from the target.

11. The device of claim 1, wherein the first surface coupler further directs the signal portion of the circularly polarized electromagnetic radiation away from the device for reflection from the target.

12. The device of claim 1, wherein the surface emitting laser is configured to emit electromagnetic radiation toward the first surface coupler of the substrate and to emit electromagnetic radiation away from the device for reflection from the target.

13. The device of claim 1, wherein the lens is a first lens to direct the signal portion of the circularly polarized electromagnetic radiation that is reflected from the target toward the device, and the device further comprises:
a second lens to direct the signal portion of the circularly polarized electromagnetic radiation away from the device and toward the target.

14. A system for light detection and ranging, comprising:
a substrate including a plurality of couplers;
a lens coupled to the substrate and configured to direct a signal electromagnetic radiation reflected from a target toward the substrate;
a plurality of photodetectors mounted to the substrate; and
a plurality of surface emitting lasers mounted to the substrate, each surface emitting laser of the plurality of surface emitting lasers coupled with a circular polarizer to generate a circularly polarized electromagnetic radiation,
wherein the substrate is configured, for each surface emitting laser of the plurality of surface emitting lasers, to:
direct, via a first coupler of the plurality of couplers, one or more of an in-phase component or a quadrature component of a local oscillator portion of the circularly polarized electromagnetic radiation toward a set of one or more interference couplers of the plurality of couplers;
direct, via a second coupler of the plurality of couplers, one or more of a first component or a second component of the signal electromagnetic radiation toward the set of one or more interference couplers; and
optically interfere, at the set of one or more interference couplers and to generate a set of optical outputs that are provided to the plurality of photodetectors, one or more of the in-phase component with the first component or the quadrature component with the first component.

15. The system of claim 14, wherein:
the first coupler directs one of the in-phase component or the quadrature component toward the set of one or more interference couplers, the set of one or more interference couplers including at least a first interference coupler;
the second coupler directs the first component of the signal electromagnetic radiation toward the first interference coupler; and
the first interference coupler couples the first component and the one of the in-phase component or the quadrature component.

16. The system of claim 14, wherein:
the first coupler directs both the in-phase component and the quadrature component toward the set of one or more interference couplers, the set of one or more interference couplers including at least a first interference coupler and a second interference coupler;
the second coupler directs the first component of the signal electromagnetic radiation toward the first interference coupler and the second interference coupler;
the first interference coupler couples the in-phase component and the first component; and
the second interference coupler couples the quadrature component and the first component.

17. The system of claim 14, wherein:
the first coupler directs both the in-phase component and the quadrature component toward the set of one or more interference couplers, the set of one or more interference couplers including at least a first interference coupler, a second interference coupler, a third interference coupler, and a fourth interference coupler;
the second coupler directs the first component of the signal electromagnetic radiation toward the first interference coupler and the second interference coupler, and directs the second component of the signal electromagnetic radiation toward the third interference coupler and the fourth interference coupler;
the first interference coupler couples the in-phase component and the first component;
the second interference coupler couples the quadrature component and the first component;
the third interference coupler couples the in-phase component and the second component; and
the fourth interference coupler couples the quadrature component and the second component.

18. The system of claim 14, wherein the first coupler comprises a two-dimensional grating coupler to direct the in-phase component in a first direction of the substrate and to direct the quadrature component in a second direction of the substrate.

19. A system for light detection and ranging, comprising:
a lens to direct a signal electromagnetic radiation reflected from a target; and
an array of unit cells, each unit cell of the array of unit cells comprising:
a surface emitting laser mounted on a portion of a substrate;
a circular polarizer to generate a circularly polarized electromagnetic radiation;
a set of one or more interference couplers formed in the portion of the substrate;
a first coupler formed in the portion of the substrate, the first coupler to direct one or more of an in-phase component or a quadrature component of a local oscillator portion of the circularly polarized electromagnetic radiation toward the set of one or more interference couplers; and
a second coupler formed in the portion of the substrate, the second coupler to receive the signal electromagnetic radiation, and to direct one or more of a first component or a second component of the signal electromagnetic radiation toward the set of one or more interference couplers,
wherein the set of one or more interference couplers is to couple one or more of the in-phase component with the first component or the quadrature component with the first component.

20. The system of claim 19, further comprising a control circuit to:
provide a control signal to cause the surface emitting laser to emit electromagnetic radiation;
receive data signals from a set of one or more photodetectors that are associated with the set of one or more interference couplers; and
determine ranging information for the target based at least in part on the data signals.
